(19) United States
(12) Patent Application Publication
(10) Pub. No.: US 2018/0285829 A1
(43) Pub. Date: Oct. 4, 2018

(54) AGENT APPARATUS AND METHOD

(71) Applicant: Sony Corporation, Tokyo (JP)

(72) Inventor: Tom HOSTYN, Halle (BE)

(73) Assignee: Sony Corporation, Tokyo (JP)

(21) Appl. No.: 15/941,082

(22) Filed: Mar. 30, 2018

(30) Foreign Application Priority Data
Mar. 31, 2017 (EP) 17164197.0

(51) Int. Cl. G06Q 10/10; G06F 9/54

(52) U.S. Cl. CPC G06Q 10/1095; G06F 17/2765; G06F 9/542

(57) ABSTRACT

An agent apparatus has an interface configured to obtain information data; an event analysis unit configured to analyze the information data for planning an event and to output an analysis result to the planning unit; and a planning unit configured to plan the event based on a set of predefined plan templates being representative of different types of events and based on the analysis result.

### TECHNICAL FIELD

The present disclosure generally pertains to an apparatus and a method in the field of agents.

### TECHNICAL BACKGROUND

Known agent services can interact with users, e.g. via speech recognition, which is implemented, for example, in an agent device.

Such agent services or agent devices can perform tasks and services for a user, such as switching lights on or off in a room, making purchase orders, etc.

Although there exist techniques for agent devices, it is generally desirable to provide an improved agent apparatus and method for controlling an agent apparatus.

### SUMMARY

According to a first aspect, the disclosure provides an agent apparatus including an interface configured to obtain information data, an event analysis unit configured to analyze the information data for planning an event and to output an analysis result to the planning unit, and a planning unit configured to plan the event based on a set of predefined plan templates being representative of different types of events and based on the analysis result.

According to a second aspect, the disclosure provides a method for controlling an agent apparatus, the method including obtaining information data, analyzing the information data for planning an event and outputting an analysis result, and planning the event based on a set of predefined plan templates being representative of different types of events and based on the analysis result.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates an embodiment of an agent apparatus and a plurality of user devices;

FIG. 2 illustrates an embodiment of a planning unit of the agent apparatus;

FIG. 3 illustrates an embodiment of an agent apparatus for running applications, and a plurality of user devices;

FIG. 4 illustrates an embodiment of an agent apparatus for running applications, and a user device;

FIG. 5 shows a flowchart of an embodiment of a method, which is used for planning an event; and

FIG. 6 is a flowchart illustrating a method for planning a walk event.

### DETAILED DESCRIPTION OF EMBODIMENTS

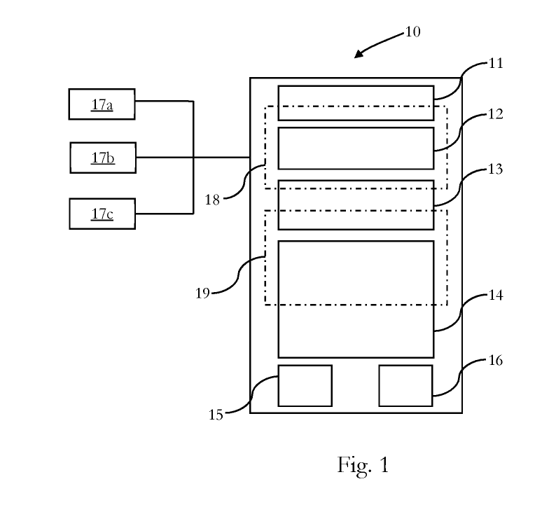

Before a detailed description of the embodiments under reference of FIG. 1 is given, general explanations are made.

As also mentioned in the outset, generally, an agent device or services or the like may interact with users, e.g. via speech recognition, which is implemented, for example, in an agent device.

It has been recognized that, for example, by listening to communications performed by a user, it is possible to assist users in planning events.

Thus, some embodiments of the disclosure pertain to an agent apparatus including an interface configured to obtain information data, an event analysis unit to analyze the information data for planning an event and to output an analysis result to the planning unit, and a planning unit to plan the event by using a set of predefined plan templates, wherein the plan templates are representative of different types of the events, and based on the analysis result.

An event may be a meeting with other persons, e.g. having lunch, going for a walk, visiting a theatre, cinema, etc. The event may also be a user activity, a task or an appointment, etc. In some embodiments, the agent apparatus is able to plan such an event, which may be automatically detected based on the information data.

The information data may be obtained, for example, from a user device, auditory user communications, online user accounts in an application in the cloud, user profiles, textual instant messaging services, audio data, video data, etc. The information data may also be obtained, for example, from at least one application running on a user device and/or from real life user communications. The information data may be obtained upon request, e.g. from a user device, or it may be automatically received, e.g. by (e. g. continuously or over certain time periods) listening to respective data, such as messaging data, audio data and/or video data, etc.

The information data may be based on or comprise personalized user information data, such as a user calendar data, habit data, plan data representing a plan, preference data, meeting data, availability data, location data, etc. The information data may also be based on an event, such that they are unique for the event represented by the information data, wherein the event can be an event detected based on the information data, or can be an event, which is recommended, based on the information data, etc.

A plan template may be a description of how to plan a specific type of event. In particular, the plan template may specify parameters, which are typically required by the agent apparatus for planning the specific type of event, e.g. event location, event time, event duration, users associated with the event, event framework, etc. Furthermore, the plan template may include logic or programming details for executing the planning. The logic applied in the plan template may enable the agent apparatus, for example, to contact dedicated services, e.g. third party services and the like. For example, a travel plan template may enable the agent apparatus to contact public transport schedules, and a restaurant visit plan template may enable the agent apparatus to book and cancel a table, etc. Furthermore, in some embodiments the plan template may also include constraints to be typically considered for planning a specific type of event (or for adapting a planning of a specific type of event), like third party dependencies (for bookings etc.), reachability of a location for the participants, availability of the participants, specific user information like dietary restrictions or age, etc.

Planning a specific event, that is, adapting a plan template for the specific event, may involve, e.g. obtaining input for the required parameters, scheduling the time and duration of the event, obtaining a list of the users associated with the event, obtaining a location of the event, planning the details for the specific event, providing the plans details to the users associated with the specific event, requesting the associated users to select between different available options for the specific event, outputting the plan, adding the plan in the calendar of the users associated with the specific event, setting a reminder to the event, etc. The obtaining of input for the required parameters may in some embodiments be based on the information data. For example, input for the required parameters might be extracted from the information data.

The planning unit may output a plan, planning details or the like for the detected or recommended (specific) event to one or more users, who are associated with this event. The planning unit may also output planning data, which can be used for scheduling the event, e.g. by inputting an appointment into a calendar of the user(s) associated with the event. The plan or planning details may also include respective reminder data, which can be used, for example, for reminding the one or more users, who are associated with the event.

The planning unit may also present the plan or planning details to the user, such that the user can decide about planning details, may select different options, such as time, location, persons associated with the event, etc.

Moreover, several plans may be combined and may further be reconciled. For example, the walk plan may be combined with a travel plan, for instance, first taking a bus (travel plan) in the start location of the walk event (walk plan), similarly, a house guest plan may be reconciled with a visit restaurant plan by adding an extra person.

In some embodiments, a plan is an instance of a plan template, wherein, it may be associated with one or more users and may further include constrains that need to be considered such as list of participants or associated users to the plan, a scheduled time, location of the plan, availability and confirmation of participants, etc., and may further include a third party dependencies such as e.g. bookings, cancelling, public transport schedule, locations to be in time, etc., and may also include a notification program, wherein associated parties (e.g. parents) may be notified.

In some embodiments, a plan for a specific event may be associated with the participants and associated persons, like parents of under-age participants. Furthermore, the plan may include necessary information about the event, like a scheduled time, a location of the event, a confirmation of participants, and notification requirements, which e.g. specify that the parents of an under-age participant have to be notified in case the plan is changed.

In some embodiments, several plans may be combined and may further be reconciled. For example, a walk plan may be combined with a travel plan, for instance, first taking a bus (travel plan) to the start location of the walk event (walk plan). Similarly, a house guest plan may be reconciled with a visit restaurant plan by adding an extra person to a reservation. The predefined set of plan templates may include plan templates for different types of events, such as a walk plan template, a restaurant visit plan template, a travel plan template, a house guest plan template, a celebration plan template, a birthday party plan template, an appointment plan template, and the like. Hence, the individual plan templates of the set of templates may be specific for/be representative of different types of events. Each individual plan template might include specific information for planning a specific type of event.

The set of predefined plan templates may be created automatically by the agent apparatus and/or may be created directly by a user. Plan templates may also be stored in a remote server and may be downloaded from a server, or they may be provided by an update to the agent apparatus, e.g. included in the firmware of the agent apparatus, or in a template file, etc. Furthermore, the set of predefined plan templates may be personalized to each user, for example, being personalized for a specific user based on the user's past event(s), etc. Moreover, a new plan template may be created based on an existing plan template, wherein a user may select one plan template out of the set of predefined plan templates, may select a new layout for the template, may further modify it (e.g. adding new requirements (parameters) to the template, and/or removing requirements from the template), and may further save it as a new plan template in the set of the predefined plan templates. In some embodiments, a user may directly create a plan template by assigning a name to the plan template and may choose different requirements that need to be considered in the plan template. For instance, a requirement for a plan template defined directly by a user may be a duration of an event, a list of users associated with the event, start time, event location, etc. The user may further save the newly created plan template in the set of predefined plan templates. For instance, the newly created plan template may be added to the set of predefined plan templates by using a scripting language, and/or by known visual programming interfaces.

In some embodiments, the event analysis unit analyzes the information data in order to determine, whether an event can be deduced or derived from the information data. For example, if the information data includes a sentence like “Do we want to go for a walk?”, the event analysis unit may (indirectly) derive that an event should be planned for the user saying this sentence. This can be performed by language/text/semantic analysis tools, as generally known, which are able to search for keywords and/or to find out the meaning of a sentence. Moreover, the information data may also include direct information or a command to the agent apparatus, e.g. “Plan to walk with family on next Sunday!”. In such a case, the event analysis unit detects the event “walk”, the participants “family” (i.e. all members of the family) and the point of time “next Sunday”. Moreover, a code word (like “plan”) may be assigned to the agent apparatus upon detection of which the agent apparatus knows that it has to plan an event.

Hence, the event analysis unit may directly detect an event which may be included in the information data, or the event analysis unit may derive an event on the basis of the information data, as exemplary discussed for the first sentence “Do we want to go for a walk?”.

In both cases, the event analysis unit may provide the analysis result, e.g. the detected or derived event (event related information), to the planning unit, which can then plan the event based on the set of predefined plan templates.

The analysis result may include information about the event, e.g. the content of the event (e.g. “walk”), the point of time of the event, participants, etc.

As the event analysis unit is able to analyze the information data, which can be audio data, text data, video data, etc., the agent apparatus may be able to automatically detect that a user may have the need to plan an event and, thus, can assist the user accordingly for planning an event.

The planning unit plans the event based on the analysis result, which, for example, identifies a type or content of event, the point of time, participants, etc., and based on the set of predefined plan templates, which are representative of different types of events.

The planning unit may map the event to a plan template of the set of predefined plan templates in such a way that, for example, the planning unit may search for keywords in the set of predefined plan templates, which match with the event indicated in the analysis results, and may use the information included in the corresponding plan template for planning the event.

Moreover, the planning unit may also enable a user to directly map a specific event, which is e.g. detected in the information data or derived based on the information data, to a template of the set of predefined plan templates.

The event analysis unit may include one or more processors, one or more microprocessors, dedicated circuits, logic circuits or the like, which may be, in some embodiments, specially designed for analyzing the information data for planning an event and/or for compiling the information data and parsing event related information and/or for detecting a sudden event based on the information data, as will also describe further below. In some embodiments, power consumption and processing time may be reduced compared to performing these tasks on a multi-purpose processor, since the circuits might be specifically tailored to their tasks. Moreover, the event analysis unit may include an interface, e.g. for communication via a local area network, a wireless network (including mobile telecommunications), Bluetooth, infrared, etc., which may be specifically designed for communication with applications running on the agent apparatus or on another apparatus. Furthermore, the interface may be adapted to communicate with other circuits included in the circuitry and/or in the agent apparatus.

The planning unit may include one or more processors, one or more microprocessors, dedicated circuits, logic circuits or the like, which may be, in some embodiments, specially designed for planning an event based on a set of predefined plan templates being representative of different types of events and/or to map the event to a plan template of set of predefined plan templates and/or for providing a plan to the users associated with the event, which is detected or derived or recommended or the like, as discussed herein. In some embodiments, power consumption and processing time may be reduced compared to performing these tasks on a multi-purpose processor, since the circuits might be specifically tailored to their tasks. Moreover, the planning unit may include an interface, e.g. for communication via a local area network, a wireless network, Bluetooth, infrared, etc., which may be specifically designed for communication with applications running on the agent apparatus or on another apparatus. Furthermore, the interface may be adapted to communicate with other circuits included in the circuitry and/or in the agent apparatus.

The interface (unit) of the agent apparatus may include one or more processors, one or more microprocessors, dedicated circuits, logic circuits or the like, which may be, in some embodiments, specially designed for obtaining information data from at least one user device, and/or one user account in the cloud, whereby power consumption and processing time may be reduced compared to performing these tasks on a multi-purpose processor, since the circuits might be specifically tailored to their tasks. Moreover, the interface may further include or may be adapted as a communication interface such as, a local area network, a wireless network, a Bluetooth, an infrared, etc., which may be specifically designed for communication with an application running on the user device and/or an application running in the cloud and/or on the agent apparatus. Moreover, the interface (or a further interface) may be adapted to communicate with other circuits included in the event analysis unit circuitry and/or in the planning unit circuitry and/or other circuitries in the agent apparatus.

In some embodiments, the agent apparatus may communicate with one or more users via an instant messaging service, for example, the notifications may be sent by instant messaging services, and may be sent to all users associated with the detected event. Hence, they can respond to the situation.

The interface may include one or more interface portions, interface units or the like, wherein different portions/units may be provided for different communication technologies, different communication content, different communication channels, etc. For instance, an interface portion for obtaining the information data may be provided and another portion for using instant messaging for providing at least one of a plan for an event, a recommendation of an event, and a notification, to the users associated with the event (detected, derived, recommended etc.).

The agent apparatus may be an electronic device, a mobile electronic device (e.g. telephone, smartphone, laptop computer, tablet computer, etc.), a personal computer, a server, a robot, etc. The agent apparatus may also include, for example, a voice recognition technology, and it may be configured to react to commands received by voice from a user. In some embodiments, the agent apparatus may be, for example, a home agent, which may be a smart speaker device with microphones. The agent apparatus may further connect to or provide an intelligent personal assistant service and/or a software agent, which may be based on for example, user input, context awareness, etc. and may further be able to access information from a variety of online sources. The software agent may be cloud-based, i.e. it may be performed at least in part at one or more remote servers or the like. The software agent in the cloud may provide high quality recognition, which may need respective computational resources, which may be provided by a remote server.

The agent apparatus may include a circuitry, one or more processors, one or more microprocessors, dedicated circuits, logic circuits, interfaces (e.g. for local network, wireless network, Bluetooth, infrared, etc.), user interfaces (e.g. keyboard, mouse, touchscreen, etc.), display means (liquid crystal display, (organic) light emitting diode based display, etc.). Moreover, the agent apparatus may further include applications to be connected to different user devices or parts of user devices, such as a global positioning system (GPS), headphone, detecting and tracking sensors, a wearable mobile kit, a Bluetooth, a microphone, a camera, an earphone, etc. The camera may be integrated in the agent apparatus or it may be separate from it, e.g. it may be wall mounted or part of a stationary agent device, or it may be worn by the user. Based on an analysis of the camera images, habits of a user may be detected and understood in more detail, for instance, when multiple users are present (people eating at home as a family), or GPS data may be disambiguated (are you in the tennis club playing tennis or in the club bar having a drink with friends), etc.

The agent apparatus may also be a user device or it may be integrated in the user device. In some embodiments, features of the agent apparatus may also be located on a plurality of user devices. In some embodiments, features of the agent apparatus may even be distributed between at least one user device and at least one agent device, or it may be (at least partially) located at a remote (cloud) server.

In some embodiments, features of the agent apparatus may also be located on one or more servers, for example, the event analysis unit in the agent apparatus may be located in the cloud or it may at least have a connection to a respective event analysis resource in the cloud, e.g. via an internet connection, etc.

As also indicated above, the planning unit may further be able to create a new plan template, it may obtain a plan template from a user device or a user may create a new plan template. This can be performed, for example, by asking a user to provide respective information, e.g. by filling in a form displayed on a display, etc. Such a new template may be used for a new type of event, which is not included in the set of predefined templates.

In some embodiments, as also indicated above, the planning unit may map an event to a template of the set of predefined plan templates. This can be done, for example, based on the analysis result, which may include information indicating the type of event. Thereby, the planning unit may be able to find a type of template, which is similar to the detected event type and, thus, the planning unit may map the event to the corresponding template.

Moreover, in some embodiments, the event analysis unit may compile the information data obtained e.g. from a user device, and/or from personal communications, etc., and may further parse event related information. Thereby, for example, semantics included in the information data can be analyzed and, thereby, events or event related information may be detected.

In some embodiments, the agent apparatus may further include a broadcast list including users associated with a detected event. Such a broadcast list may be e.g. a family broadcast list, a business broadcast list, a project participant broadcast list, etc. Furthermore, the agent apparatus may be able to obtain information data for (each) members in the broadcast list and may consider the user information data in planning an event.

In some embodiments, a plan may include multiple participants and may further include third party implications when cancelled.

Moreover, a user typically has a number of habits, which may be automatically detected in some embodiments, e.g. by the agent apparatus, or respective habit information may be received over the interface. A habit may describe recurring events (characterized e.g. by a certain time, duration, place etc.) in the past. The agent apparatus may then predict future events based on the user habits. The agent apparatus may further recommend the event, provide a plan to the users associated with the event, and may further add the plan to the calendars of the users associated with the event.

In some embodiments, the agent apparatus may plan an event e.g. based on a set of predefined plan templates being representative of different types of events and based on the analysis of the information data obtained through data connections, for example, by wireless synchronization with a user device performed over the interface. Moreover, the planning unit may further provide the plan for the event to the user(s) associated with the event.

In some embodiments, the agent apparatus may further include a probability estimation unit and may compute a probability for a user activity, e.g., based on a statistical analysis of the activity of the user in the past and the information data. The probability estimation unit may also use the user habits. For example, the agent apparatus may determine that the user has dinner every Friday with a specific person, e.g. his wife. Then the probability estimation unit may compute, for example, that there is a high probability that the user will go to this restaurant with his wife next Friday too. The probability estimation unit may also use the analysis results of the event analysis unit for computing the probability.

The probability estimation unit may include one or more processors, one or more microprocessors, dedicated circuits, logic circuits or the like, which may be, in some embodiments, specially designed for computing a probability for a user activity based on a statistical analysis of the activity and information data. Moreover, the probability estimation unit may include an interface, e.g. for communication via a local area network, a wireless network, Bluetooth, infrared, etc., which may be specifically designed for communication with applications running on the agent apparatus or on another apparatus. Furthermore, the interface may be adapted to communicate with other circuits included in the circuitry and/or in the agent apparatus.

In some embodiments, the agent apparatus may further recommend an event to the user, and the planning unit may further plan the recommended event based on the information data obtained through data connections, such as, by wireless synchronization with a user device performed over the interface.

In some embodiments, the probability estimation unit may compute a probability for a user activity based on a statistical analysis of the user's past activities and the information data, the user activity may further be recommended as an event, and the planning unit may further plan the recommended or predicted event based on the information data obtained through data connections, such as, by wireless synchronization with a user device performed over the interface.

In some embodiments, the probability estimation unit may assign a higher probability for a frequently performed user activity and the planning unit may further recommend the frequently performed activity as a recommended event (e.g. having dinner with the wife on Friday in the example given above).

A user may be a member of a broadcast list, e.g. a member of a broadcast list created for a family, e.g. including (all) family members living together. Each user may have a calendar, which includes events. Moreover, the events may include information (e.g. details of the plan for the specific event, or the plan itself) such as the event time, the event location, list of participants of the event, etc. Furthermore, an event may have a probability of occurring. For example, events confirmed by the user may have, for example, an occurring probability of “1”, and the events predicted by the agent apparatus may have a lower probability.

Furthermore, the probability of a user activity may be reflected in the confidence of the prediction. The agent apparatus or the probability estimation unit may estimate a probability for a user activity or a user habit based on the obtained information data and statistical analysis of the user activity and/or the user habit. Moreover, the events may be recommended based on the user activities and/or the user habits, and the recommended events may further be planned by the planning unit. The planning unit in the agent apparatus may plan the recommended events based on their probability and may further add the planned events in the user calendar. For example, the probability estimation unit may assign a high probability of occurring for a specific user activity in the next week, in the case that the user consistently performed the activity in e.g. the past 10 weeks. Therefore, the agent apparatus may automatically define this user activity as an event, and the planning unit may further plan the event. The planning may involve other family members and may further involve third parties.

In addition, the user habits may be used to determine preferences, such as preferred time to eat, preference to engage in specific sports at certain time, a cuisine preference and the like. Moreover, the preferences may be used by the agent apparatus in planning and/or recommending an event to the user.

In some embodiments, the agent apparatus may further include a tracking unit and may track the users associated with a planned event. The tracking unit may include a camera, acceleration sensors, positioning sensors, and the like, but it may also use respective information about the location of a user for tracking the user.

The tracking unit may include one or more processors, one or more microprocessors, dedicated circuits, logic circuits or the like, which may be, in some embodiments, specially designed for tracking time and location of the users associated with the planned event. In some embodiments, power consumption and processing time may be reduced compared to performing these tasks on a multi-purpose processor, since it is specifically designed for the specific task. Moreover, the tracking unit may include an interface, e.g. for communication via a local area network, a wireless network, Bluetooth, infrared, etc., which may be specifically designed for communication with applications running on the agent apparatus or on another apparatus. Furthermore, the interface may be adapted to communicate with other circuits included in the circuitry and/or in the agent apparatus.

In some embodiments, the tracking unit may track time and location of the users associated with the planned event. Thereby, for example, it can be detected whether the (all) users associated with the event will be able to participate and/or whether the event takes place. Moreover, for example, parameters associated with the event, e.g. weather conditions or the like, may be monitored. For example, when the event is “going for a walk” and the weather changes and a storm is coming, the users participating in the event may be notified.

In some embodiments, the event analysis unit may further detect a sudden event based on the information data and based on the tracking of the user associated with the (detected) sudden event. Such a sudden event may be an unplanned event, which, for example, might cause the plan for a planned event to be amended or it may trigger planning of a new event. For example, the user plans to meet at a certain point of time, but will come too late, since he is in a traffic jam, which is a sudden event. Another example of a sudden event may be an accident, e.g. a car accident, a car break down or the like. In both cases, the agent apparatus may detect that the user will come too late to a planned event, since another transport means is needed. As a consequence, the agent apparatus may adapt the plan for the planned event, e. g. postpone the planned event.

In some embodiments, the agent apparatus may further include a notification unit and may provide an alert notification to the users associated with the planned event.

The notification unit may include one or more processors, one or more microprocessors, dedicated circuits, logic circuits or the like, which may be, in some embodiments, specially designed for providing an alert notification to the users associated with the planned event. In some embodiments, power consumption and processing time may be reduced compared to performing this task on a multi-purpose processor, since it is specifically designed for performing the specific task. Moreover, the notification unit may include an interface, e.g. for communication via a local area network, a wireless network, Bluetooth, infrared, etc., which may be specifically designed for communication with applications running on the agent apparatus or on another apparatus. Furthermore, the interface may be adapted to communicate with other circuits included in the circuitry and/or in the agent apparatus.

In some embodiments, the agent apparatus may communicate with an application installed on the at least one user device. The agent apparatus may consider a user's lifestyle, for example, on the basis of processing of the information data obtained from the user device or multiple users communications.

The planning unit may be able to plan a specific event and thereby create a plan for the event, to update the plan, to cancel the event, to reconcile a plan with other plans and the like. The planning unit may further involve contacting dedicated services, such as a third party service. The planning unit may also be able to execute the plan and it may have further capabilities for executing the plan. For example, for executing a travel plan the planning unit may be able to obtain public transport schedule information, for executing a restaurant visit plan the planning unit may contact a third party service for booking and/or editing and/or canceling a table online, etc. Moreover, the planning unit may further be adapted to combine and reconcile several plans, e.g. a walk plan may be combined with a travel plan or a house guest plan may be reconciled with a restaurant visit plan by adding one extra person.

Generally, the agent apparatus may be based on machine learning algorithms.

For example, the agent apparatus or its planning unit and/or its event analysis unit may be further configured to map an event to a template of the set of plan templates and/or may be configured to plan the event based on the obtained information data and based on a set of predefined plan templates by using machine learning algorithms.

In some embodiments, the planning unit is adapted to plan the event, e.g. based on machine learning algorithms, while in other embodiments the machine learning algorithms may be performed at another location, e.g. on a remote server or the like, which plans the event and provides the plan to the agent apparatus. In some embodiments, the machine learning algorithms may be performed on a remote server, for example based on combining the information data of a plurality of users associated with the planned event or other users which are associated with the agent apparatus and for which the agent apparatus has user profiles. Moreover, in some embodiments, also (anonymous) user profiles of other users may be used for machine learning, e.g. in order to detect user habits and the like. Typical machine learning algorithms, which may be used alone or in combination in some embodiments for providing the plan of the planning unit are: decision tree learning, association rule learning, artificial neural networks, deep learning, support vector machines, Bayesian networks, dimensionality reduction algorithms, naive Bayes, logistic regression and the like. Moreover, in some embodiments, a plan may be generated by the planning unit based on machine learning algorithms, as mentioned above, such as decision tree learning, association rule learning, artificial neural networks, deep learning, support vector machines, Bayesian networks, dimensionality reduction algorithms, naive Bayes, logistic regression and the like.

An application as discussed herein may be a software program, which can be executed e.g. by a processor of the agent apparatus, the user device and/or a plurality of users devices. Furthermore, the information data, the event related data, the plan template data, and the tracking data may be generated by an associated application either on the agent apparatus and/or on a user device and/or on a remote server. In some embodiments, the information data, the event related data, the plan template data, the plan data, and the tracking data can only be interpreted by the application, which generated them, for example, since the meaning of the specified generated data may only be known by the associated application which generated the data. Moreover, in some embodiments, the agent apparatus or its event analyzing unit may be configured to detect a sudden event based on the information data and may further provide an alert notification to the users of a planned event concerned by the detected sudden event, as discussed above. In such an embodiment, the notification unit may be omitted.

As mentioned, in some embodiments, the agent apparatus provides an alert notification based on the detected sudden event, and/or based on the tracking of the users associated with the event, and/or based on the obtained information data. The notification may include, for example, a text message (data), an audio message (data), a statement (data), or the like and may be provided via instant messaging. The notification unit may have the task to provide a notification for the event planned for a user and the notification may be associated with a certain time of the event, before occurrence of the event or after occurrence of the event, or it may be associated with the location of the event and the like. The notification may be predetermined and may include, for example, information about the time, location and the like.

The agent apparatus may further include a recognition feature, for instance, a speech recognition feature (e.g. including a microphone for capturing an audio signal and a voice recognition software), and the like, and, thus, may be capable of obtaining the commands directly from the user communication and/or through a microphone, a loudspeaker and the like. Moreover, the agent apparatus may be configured to be used together with an instant messaging application and/or may be located in the cloud or on the server.

Furthermore, as mentioned above, the agent apparatus may include a notification unit and may provide an alert notification to the user in the detected event. In some embodiments, based on the tracking of the event and the users associated with the event, an alert notification may be displayed on a display, e.g. of the agent apparatus, and/or may be outputted, wherein displaying the alert notification, for example, may be based on at least one of: a text, an icon, graphical representation of an item, and wherein outputting the alert notification, for example, may be based on at least one of: a sound, a vibration of the device, or the like. The alert notification may be displayed by an application running on the agent apparatus, wherein the application may receive the alert notification data.

The agent apparatus may generate a plan (plan an event) based on a data generation algorithm, which uses the obtained information data from the user device as input. The data generation algorithm may be based on a Bayesian network, on clustering model or other approaches, which are known, and which are also mentioned above with respect to machine learning.

In some embodiments, the planning of an event by the planning unit may be performed based on the obtained information data of different users (e.g. mentioned in a broadcast list, as being discussed above) being associated with the same activity or plan. Thereby, a large data set of the information data may be obtained and a (global) machine learning algorithm may be performed using the large data set of the information data input data. As mentioned, such a global machine learning algorithm may also be performed at another location, e.g. a remote server or the like, which provides information data via the interface to the agent apparatus.

As mentioned, the agent apparatus may collect the information data from the (at least one) user device and may, for example, transmit the obtained data to a remote computer, e.g., an remote agent platform or the like, on which a machine learning algorithm or the like is performed in order to plan an event.

In some embodiments, it is avoided to leave a trace of the information data on, for example a permanent storage outside the agent apparatus (e.g. in the cloud). In some embodiments, the information data are only needed for planning an event and they may be deleted afterwards.

In some embodiments, the user device has a global positioning system (GPS) receiver/sensor, for finding the user location and/or the event location, and the agent apparatus may provide an alert notification based on the user location received from the user device.

In some embodiments, the agent apparatus may further include a detailed plan option, dynamic “to-do” lists and other features, which may be used for assisting a user at an event or managing events.

In some embodiments, the agent apparatus may incorporate further device options, such as a camera. Moreover, the agent apparatus may have further functions, such as a photo-attachment function, a combination of a text, a video, and a photo attachment option e.g. for including further text, video and/or photo information in the plan, in the alert notification, etc.

In some embodiments, the agent apparatus may have the ability to include attachments to the detected, derived, recommended, etc. events e.g. a file, a note, adding photo to each event, etc., and may further ensure that (all) users associated with the detected, derived, recommended, etc. event have access to identical event information. For example, the agent apparatus may include a comment, an announcement, a question means or the like, and may further allow the users to discuss event related information.

In some embodiments, in addition to the ability to plan and track an event, the agent apparatus may further include a plan management that may let a user to organize, add, and check-off tasks from the agent apparatus device, and/or may further include a plan management for collaborating with at least one member of a broadcast list, e.g. for collaboration in a common detected event.

In some embodiments, the agent apparatus may allow a user to access (all of) the planned events, so that the user may move an event and/or a plan, to prioritize a plan or event, to add a “to-do” list, etc. The agent apparatus may include a check off option for marking when an event is completed, an attach file option for attaching files from file storage systems, e.g. in the cloud, etc.

In some embodiments, the agent apparatus may notify a user about an upcoming event and allow the user to organize events by priority, to add an event note, and provide event updates to the user device, as they happen.

In some embodiments, the agent apparatus may create a specific workspace, which can be accessed by users associated with an event, and it may further set permissions to make sure that only predetermined users have access to the event related information.

In some embodiments, the agent apparatus may send an invitation to the users associated with the event, and may further obtain/provide information to all users associated with the event, e.g. by adding an event to their calendar and/or to look out for upcoming events in users calendar.

In some embodiments, the agent apparatus may have a synchronization function that automatically synchronizes planned events in different devices, e.g. adds a planned event to all user calendars in all user devices and the like.

In some embodiments, the agent apparatus may further backup and restore e.g. the plans, the plan templates, or the agent apparatus may further configured to import and/or export the plan templates.

In some embodiments, the agent apparatus may request a confirmation from the user(s) associated with the event before planning the event, particularly, when a financial transaction with a third party service or some other irreversible action in planning is involved.

In some embodiments, an agent apparatus application/program may have a layout and design, which is similar to a known calendar on the user devices, and/or it may be able to use the already installed calendar applications on the user devices.

In some embodiments, the user may be able to pick from a day, a week, a month, etc., and agenda view, wherein a calendar may be provided to the users of the agent apparatus including events with planning details like time, location, list of the associated users (participants in the event) and notes for every event.

In some embodiments, users may choose with whom they share the information and may limit the obtained information

In some embodiments, the agent apparatus may send further event related information, such as a map, address, opening date, etc., to the users associated with the event.

Some embodiments pertain to an agent method or method for controlling an agent apparatus, such as described herein, including obtaining information data, analyzing the information data for planning an event and outputting an analysis result, and planning the event based on a set of predefined plan templates being representative of different types of events and based on the analysis result, as discussed above. The agent method may be performed by the agent apparatus as discussed herein, by one or more processors, by a circuitry, by logic circuits and the like, by an electronic device (computer, mobile phone, smart phone, tablet pc, pc, server, etc.) or any other device which is capable of electronically performing a method.

As discussed, the information data may comprise personalized user information data, such as user calendar data, user habit data, plan data, preference data, meeting data, availability data, location data, etc. The information data may be further directly or indirectly represent an event, as discussed above.

The agent method may include mapping the event to a plan template of the set of predefined plan templates, as discussed above.

The agent method may further include creating a new plan template, as discussed above.

The agent method may further include compiling the information data and parsing event related information, as discussed above, which may be used for analyzing the information data for planning an event, as discussed above. For example, the agent apparatus may access an application/program running on its event analyzing unit and may further perform a check to ensure that nothing is ambiguous in the obtained information data, and may further, initiate a particular function identified for parsing/compiling the information data. The event analysis unit and/or the application running on its processor may also ensure that the order in which keywords are used, in order to form meaningful instructions, is correct, and may further convert the obtained information data step by step into the machine language.

The agent method may further include using instant messaging for providing at least one of: a plan, a recommendation of an event, and a notification, e.g. the agent apparatus may detect an event in an instant messaging applications, and the planning unit may further generate a plan, and the agent apparatus may further provide the plan in an instant messaging application, as discussed above.

Furthermore, the agent apparatus may access an application/program running on its event analyzing unit and may further parse the compiled information data before being transformed into executable machine code, and may further send event related information data, such as users associated with the event, time, location, type of event, etc., to the planning unit in the agent apparatus, as discussed above.

The agent method may further include providing a plan based on the information data, as discussed above, wherein the plan is provided, e.g., by the planning unit based on the obtained information data.

The agent method may further include computing a probability for a user activity based on a statistical analysis of the activity and the information data, as discussed above, and on the basis of the probability a plan may be generated.

The agent method may further include recommending a frequently performed activity as a recommended event, as discussed above.

The agent method may further include tracking users associated with a planned event, as discussed above.

The agent method may further include tracking time and location of the users associated with the planned event, as discussed above.

The agent method may further include detecting a sudden event based on the information data, as discussed above.

The agent method may further include providing an alert notification to the users associated with a planned event concerned by the sudden event, as discussed above, wherein the notification is provided by the notification unit and may include a text, a message, and the like, as discussed above.

The methods as described herein are also implemented in some embodiments as a computer program causing a computer and/or a processor and/or a circuitry to perform the method, when being carried out on the computer and/or processor and/or a circuitry. In some embodiments, also a non-transitory computer-readable recording medium is provided that stores therein a computer program product, which, when executed by a processor and/or a circuitry, such as the processor and/or a circuitry described above, causes the methods described herein to be performed.

Returning back to FIG. 1, an embodiment of an agent apparatus 10 is illustrated. The agent apparatus 10 has an interface 11, an event analysis unit 12, a probability estimation unit 13, a planning unit 14, a tracking unit 15, and a notification unit 16.

The interface 11 communicates with a plurality of user devices and/or user applications, including a user device 17a, a chatbot user application 17b, which conducts conversation with the user, and a dedicated UX user experience application 17c.

The user device 17a may include a voice interaction transducer, such as a microphone, a speech recognition sensor, or a loudspeaker and may further include a location detection sensor (not shown).

The chatbot user application 17b may include an instant messaging application e.g. a messaging communication service, and may, in other embodiments, also reside in a cloud server or on a user device 17a.

The agent apparatus 10 further includes a processor 18, which is connected to a storage 19 and the interface 11. The storage 19 includes a random access memory (RAM) and a hard disk.

The interface 11 communicates with a mobile telecommunication system, e.g. LTE, GSM or the like, for obtaining information data. It also provides access to a local area network (LAN) and performs a wireless communication with a wireless local area network. Additionally, it may communicate over Bluetooth.

Thereby, the agent apparatus 10 can establish a connection to the internet. Hence, the agent apparatus 10, the user devices/applications including 17a, 17b and 17c may communicate over a network e.g. LAN, Wifi, etc. and/or the internet with each other.

The agent apparatus 10 is able to communicate with the user devices 17a, 17b and 17c for obtaining information data. Thereby, e.g. during communication, the event analyzing unit 12 in the agent apparatus 10 is able to analyze the information data e.g. by compiling all obtained information data and parsing the event related information.

Furthermore, when a sudden event is detected by the tracking unit 15 based on the obtained information data, the user is specifically notified by receiving an alert notification from the notification unit 16 in the agent apparatus 10, for example, the agent apparatus 10 may send a reminder notification to the user device, when the user forgot a planned appointment.

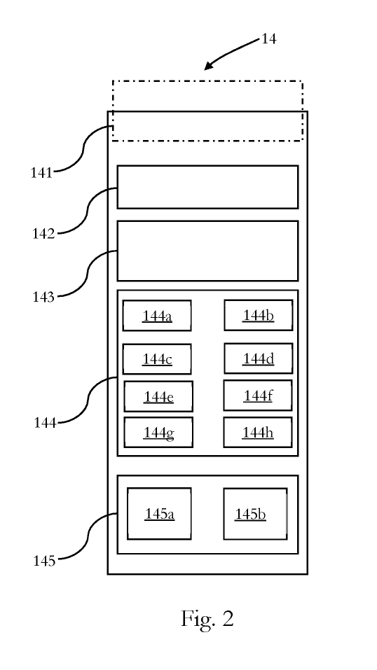

FIG. 2 illustrates an embodiment of the planning unit 14, wherein the planning unit 14 has an interface 141, a plan classification section 142, a plan recommendation section 143, a set of the predefined plan templates section 144, and a new plan template creation section 145.

Furthermore, the interface 141 in the planning unit 14 is configured to communicate with other sections in the planning unit 14 and with other circuitries in the agent apparatus 10, for example to communicate with the event analyzing unit 12 in the agent apparatus 10 for obtaining the event related information data.

As discussed above, the event analyzing unit 12 provides the event related information data to the planning unit 14. In the present embodiment, the obtained information data are compiled and the event related information data are parsed with machine learning algorithms including an artificial neural network, which uses the information data, obtained from the user device 17a, 17b and 17c as input.

The planning unit 14 further includes a mapping section 142, which maps the event to a template of the set of predefined templates, based on the analysis data. Additionally, the planning unit 14 includes a plan recommendation section 143, which provides a plan for detected events to one or more users associated with the detected event. The event can be derived, as discussed, e.g. from user habits, the detected events in user accounts, user commands, etc. The plan recommendation section 143 may also provide a set of predefined plan templates 144 including predefined templates for different event.

The exemplary predefined plan templates presented in FIG. 2 are: walk plan template 144a, restaurant plan template 144b, travel plan template 144c, house guest plan template 144d, birthday party plan templates 144e, appointment plan template 144f, third party shopping plan templates 144g, and financial plan templates 144h.

The predefined plan template section 144 may further include additional plan templates.

Furthermore, the planning unit 14 has a new plan template creation section 145, which assists in creating a new plan template. A new plan template can be created, for example, in the case that a new type of event is detected, which does not fit to any one of the templates of the set of the predefined plan templates. The new plan template creation section 145 includes two sections, a section 145a for creating a new plan template directly by the user and a section 145b, wherein the planning unit 14 may create a new plan template, independently from a user input.

As discussed above, the planning unit 14 learns by analyzing the event related information data received from the user device 17a, 17b and 17c. Moreover, the planning unit 14 may also analyze the communication and may thereby learn. Of course, any type of information represented by the event related information data can be used for training of the artificial neural network for providing the plan, creating a new plan template, etc.

The agent apparatus 10 and the user device 17a, each have a display (not shown), which is exemplary based on LED-technology and is configured as a touch screen without limiting the present disclosure in that regard.

The entire agent apparatus 10 including the interface 11, the event analysis unit 12, the probability estimation unit 13, the planning unit 14, the tracking unit 15, and the notification unit 16, the processor 18, and the storage 19 may form a circuitry as discussed herein.

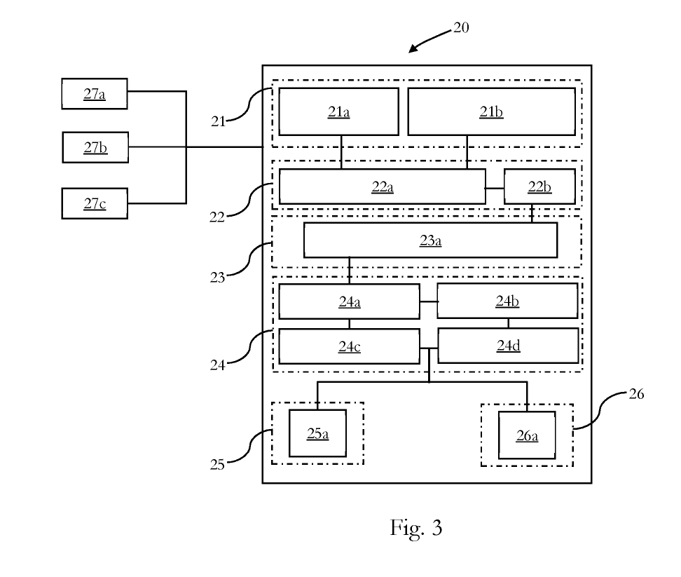

As illustrated in FIG. 3, in some embodiments, an agent apparatus 20 includes one or more programs, which can be computer programs, application programs and the like.

In the following, the interplay of the agent apparatus 20 having an interface 21, an event analysis unit 22, a probability estimation unit 23, a planning unit 24, a tracking unit 25, a notification unit 26, a plurality of user devices and user applications 27a, 27b and 27c, a processor 28, and a storage 29 is discussed.

The agent apparatus 20 of FIG. 3 is similar in its functionality to the agent apparatus 10 of FIG. 1.

The agent apparatus 20 may be a platform for several programs/applications, which handle the information data from the user device 27a, and user applications 27b and dedicated UX user accounts 27c and may provide a plan, as also discussed above.

The interface 21 in the agent apparatus 20 may implement two programs, a first program 21a for obtaining the information data from the user device 27a, wherein such information can be obtained, for example, by receiving it from a microphone, from a loudspeaker, a dedicated UX user experience 27c, etc., and a second application/program 21b for obtaining the information data from user accounts and user applications running in the Cloud 27b, such as e.g. online instant messaging on external servers, user accounts in the internet, user backup data stored in the internet and additional online chatbot, which may further include additional interpretation of data and may handle obtaining different types of data from the application 21a.

The data obtained by programs 21a and 21b are transmitted to the event analysis unit 22, e.g. over an internal bus system, or other connections.

Moreover, several applications/programs are installed on the event analysis unit 22.

In FIG. 3, an exemplary application 22a is installed for compiling the obtained information data and an application 22b is installed for parsing the event related information. The application 22b may further detect a sudden event based on the event related information data.

The event related information is transmitted from the event analysis unit 22 as an analysis result to the probability estimation unit 23, wherein an application 23a is installed on the probability estimation unit 23 for computing a probability for the detected event or for other user activities. The application 23a may compute a probability for an activity based on a statistical analysis of the activity and obtained information data, where a user activity that has been occurred several times may have a higher probability and may be considered as an event to be recommended and planned.

In addition, in the case where a new plan from a user is provided to the agent apparatus 20, e.g. through a voice command to the agent apparatus 20, the application 23a on the probability estimation unit 23 may set a higher probability to the new plan.

Next, the planning unit 24 receives the detected event with estimated probability for each event along with event related information data from the application 23a. The data are transmitted e.g. over an internal bus system, or other connections.

Furthermore, applications 24a, 24b, 24c and 24d are installed on the planning unit 24 of the agent apparatus 20.

The application 24a is used for mapping the event to a template of a set of the predefined plan templates, and the application 24b is used for planning the event based on the obtained information data, and for providing the plan to the user device 27a. In some embodiments, the application 24a may further include a plan editing or cancelling a planned event function.

The two applications 24c and 24d are installed on the planning unit 24 for planning events related to third party services and for creating new plan templates, respectively.

Likewise, the data are transmitted to the tracking unit 25 and to the notification unit 26, e.g. over an internal bus system, or other connection.

The agent apparatus 20 further includes an additional application 25a on its tracking unit 25 for tracking time and location of the users associated with the planned events.

Furthermore, the notification unit 26 on the agent apparatus 20 includes an application 26a for providing an alert notification for example to the user device 27a, as discussed above.

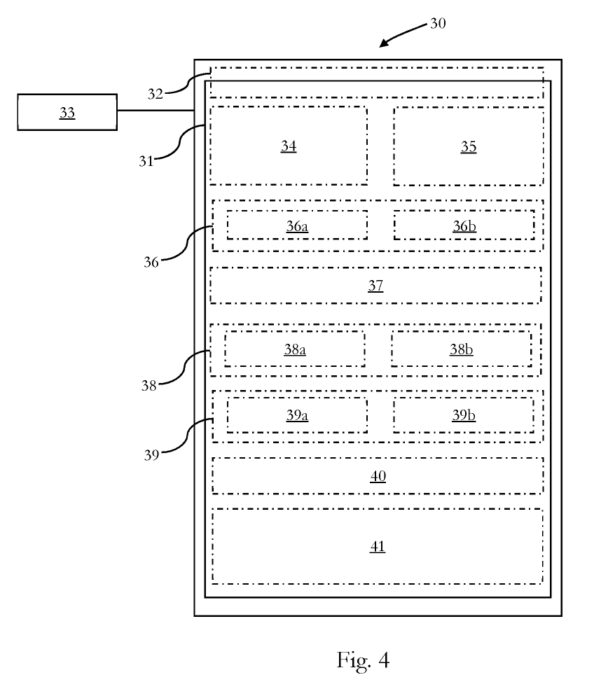

FIG. 4 illustrates an agent apparatus 30, which may also form the basis for an electronic circuit, a smartphone, a server, a computer or the like, as discussed above.

The agent apparatus 30, has a display 31, and an interface 32, and may be connected to a user device 33, as discussed above. Moreover, the agent apparatus 30 has a processor 34, a storage 35, an event analysis circuit 36, a probability estimation circuit 37, a planning circuit 38, a tracking circuit 39, a notification circuit 40, and an application circuit 41, wherein entities 36 to 41 may communicate with 34 and/or 41 over an internal bus or the like for communicating information.

The event analysis circuit 36 has an event analysis compiling unit 36a, which may include a processor, logic circuits and the like, and an interface 36b over which it can communicate to the event analysis compiling unit and/or to obtain the information data from the user device 33 and the detected event related information data from the event analysis compiling unit 36a.

The probability estimation circuit 37 may include a processor, a logic circuit and the like, and it may be specifically designed for computing a probability for a user activity based on a statistical analysis of the activity, e.g. an executable code that expresses execution of a specific action to be carried out, such as detecting a user location based on GPS information from a GPS sensor of the user device and assigning a higher probability for a task (event) that has been multiple times occurred on a same location, e.g. a weekly gym activity, as it discussed above.

The planning circuit 38 has a plan generator 38a, which generates for instance a plan based on a set of predefined plan templates that are representative of different type of events, and/or generates a new planed template. Moreover, the circuit has an interface 38b over which it can communicate the plan to and/or receive the information data from the user device 33 or from other circuitries in the agent apparatus. For example, the interface 38b may be used for obtaining a new plan template, which is created directly by the user.

The tracking circuit 39, has a time and location tracking management system 39a, which automatically tracks the location and time of the users associated with the planned event, such as following, for example, a user local position and time, time spent in an appointment, and total time for completing a plan, etc. These functions may also be implemented in the planning circuit 38.

Moreover, the circuit has an interface 39b over which it can communicate the tracking information of the users associated with the planned event and/or receive the information data, to/from the user device 33 or other circuitries in the agent apparatus.

The notification circuit 40 may include a processor, a logic circuit and the like, and it may be specifically designed for providing an alert notification e.g. a text message alert, an audio message alert, or an executable code that expresses preformation of a specific action to be carry out such as an “If-then” control flow statement, as it discussed above.

The application circuit 41 may include a processor, logic circuits and the like, and it may be specifically designed for performing applications.

As discussed above, the applications running on the application circuit provide the plan and the alert notification, wherein the plan circuit generates the plan with 38a, and receives the data through the interface 38b.

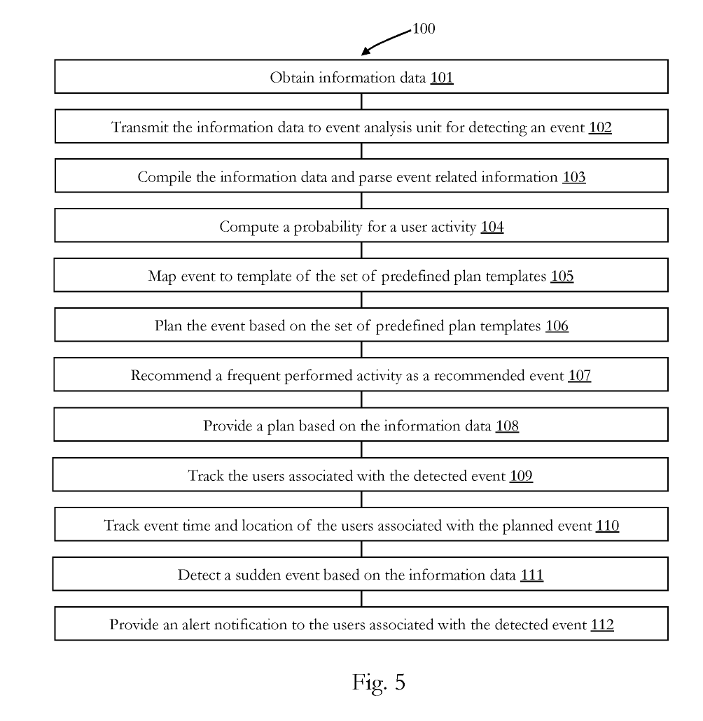

A method 100 for controlling an electronic device, such as an agent apparatus 10, 20, and 30 as discussed above, is described in the following under reference of FIG. 5. The method can also be implemented as a computer program causing a computer and/or a processor and/or circuitry, to perform the method, when being carried out on the computer and/or processor and/or circuitry. In some embodiments, also a non-transitory computer-readable recording medium is provided that stores therein a computer program product, which, when executed by a processor, such as the processor described above, causes the method described to be performed.

FIG. 5 illustrates a flow diagram of the method 100 for providing the plan by an agent apparatus based on the obtained information data from the user device.

In the following, the method 100 for providing the plan is discussed, which can be performed by an agent apparatus (e.g. 10, 20 or 30), as described herein, wherein, without limiting the disclosure in this regard, the discussion is exemplary focused on the agent apparatus 20.

At 101, the information data are obtained from at least one user device, e.g. 27a, 27b, 27c of FIG. 3, as discussed above. The information data may be obtained by application 21a running on the interface circuit 21, as discussed above. As mentioned, the information data may be obtained directly from a user device or from accessible user accounts in the cloud, third party applications, etc.

At 102, the interface 21 communicates with the event analysis unit e.g. 22 in FIG. 3, running on an apparatus, (e.g. smartphone, tablet, etc.), and provides the information data to it, as discussed above.

The information data may be obtained by the application 22b running on the event analysis circuit 22, as discussed above.

At 103, the obtained information data may be displayed, compiled and analyzed by the event analysis circuit, e.g. 22 in FIG. 3, which outputs an analysis result, and event related information, such as time, location, associated users, event type, etc. may be parsed and the possible events may be detected, as discussed above. The information data may be compiled by the application 22a, and the event related information may be parsed by the application 22b, running on the event analysis circuit 22 in FIG. 3, as discussed above.

At 104, the event related information data are provided to the probability estimation circuit, e.g. 23 in FIG. 3, and a probability for a detected user activity, i.e. event, is computed. The application 23a on the probability estimation circuit 23 may compute a probability for a detected user activity, which may use for planning an event, based on the statistical analysis of the user activity and on the obtained information data, as discussed above.

At 105, the information data, the detected events, the event related information data, and the probability data for detected events and the user activities representing an event are transmitted to the planning unit (e.g. 24). The identified event is mapped to a template of the set of predefined plan templates being representative of different types of events by application 24a running on the planning circuit 24, as discussed above.

At 106, a plan may be generated and may be provided for detected events by an application 24b running on the planning unit 24, wherein the plan and the event(s) may be presented to the user(s) associated with the event. Moreover, in the case a third party communication is required for planning the event, an application 24c may communicate with third party applications or request a confirmation action from the user.

In addition, the plan may be generated based on the set of predefined plan templates, however, in the case an activity is detected, which does not relate to or fit to any of the predefined plan templates, an application 24d running on the planning unit 24 may create a new plan template, independently from a user input or may obtain a new plan template from the user, as discussed above.

At 107, the planning unit 24 further recommends a frequent performed activity by the user as a recommended event, wherein the activity may be analyzed by the application 22a running on the event analyzing unit 22, and wherein the communication may be conducted by the application 21a, running on the interface unit 21, as discussed above.

At 108, a plan may be generated and may be provided for a frequent performed activity of the user, which is represented by the recommended event to be planned. Furthermore, the plan may also be provided for the case that a user designates a command to the agent apparatus and requests for a solution. The plan may be provided by an application 24b running on the planning unit 24, as discussed above.

At 109, the agent apparatus 20 tracks the users associated with the planned event. The tracking may be performed by an application 25a running on the tracking unit 25 on the agent apparatus 20, as discussed above.

At 110, the tracking unit may further track the location of the users associated with the planned event and, for example, the time of the event in order to recognize if a user comes late or the like. The tracking may be performed by the application 25a running on the tracking unit 25 on the agent apparatus 20, as discussed above.

At 111, the event analysis unit may detect a sudden event based on the obtained information data. The sudden event may be detected by the application 22a, running on the event analysis unit 22, as discussed above.

At 112, an alert notification may be provided to the user(s) associated with the event. The alert notification may be provided by application 26a running on the notification unit 26, on the agent apparatus 20, as discussed above.

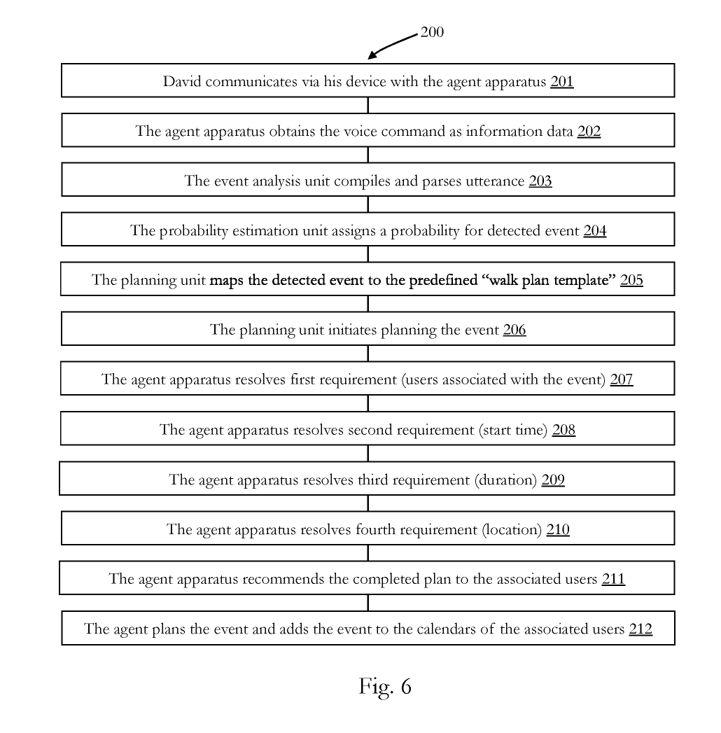

FIG. 6 shows a method 200, which may exemplary be performed by the agent apparatus 20 for planning a walk event.

At 201 a user with the arbitrary name David communicates via his device, e.g. 27a in FIG. 3, with the agent apparatus, e.g. 20 in FIG. 3, through a voice command, such as; “Agent, I want to plan a walk with the family on Sunday Feb. 7, 2017”.

At 202, the agent apparatus 20 obtains the voice command as information data via an application 21a on its interface 21 and transmits the information data to the event analysis unit 22 in the agent apparatus 20.

Next, at 203, the event analysis unit 22, compiles the above command with an application 22a and parses utterance via application 22b, wherein the result of the parsed utterance may be as follow:

“I want to plan a walk with the family”

and the application 22b further detects an activity of “walk” as an event, which needs to be planned, and further provides the event related information data, e.g. time, location, associated user(s), route, etc., as analysis result to the probability estimation unit 23 and to the planning unit 24, respectively.

Next, at 204, the probability estimation unit 23 assigns a probability of “1” for planning this event, since a designated command issued by the user for planning the walk was detected and the planning unit 24 on the agent apparatus 20 begins to plan the event.

Next, at 205, the application 24a running on the planning unit 24, maps the detected event to the predefined template of “walk plan template”, and at 206, the application 24b initiates planning the detected event.

The application 24b, on the planning unit 24 fetches the predefined plan template of “walk plan template”, wherein the template requires additional information to be obtained from the user or from the parsed information data as follows. Exemplary four additional requirements for the “walk plan template” are presented below:

Requirement 1: users associated with the event=NIL; obtain from user or from the information data

Requirement 2: start time=NIL; obtain from user or from the information data

Requirement 3: duration=NIL; obtain from user or from the information data

Requirement 4: location=NIL; obtain from user or from the information data wherein, NIL is not in the list.

The application 24b resolves all above requirements through a “step by step process”.

In the following, four actions are presented for the “walk plan template”, which includes the four above requirements that need to be fulfilled.

Action 1:

At 207, in action 1, the agent apparatus resolves the first requirement 1 (users associated with the event) based on the obtained information data, and detects the word “family” based on the obtained information.

The agent apparatus further adds the family member from the broadcast list “family” in user contact information, hence, for an arbitrary family broadcast list with arbitrary names of Alice, Bob, and Charlie, the requirement features of a predefined “A walk plan template” is as follows:

Requirement 1: users associated with the event=David, Alice, Bob, and Charlie

Requirement 2: start time=NIL; obtain from user or from the information data

Requirement 3: duration=NIL; obtain from user or from the information data

Requirement 4: location=NIL; obtain from user or from the information data and moves forward to the next action.

Action 2:

At 208, in action 2, the application 24b on the agent apparatus 20 resolves the second requirement 2 (start time) for the exemplary predefined “walk plan template”.

The agent apparatus 20 checks the calendars of the family members David, Alice, Bob, and Charlie (users associated with the detected event), and detects the available times on their calendars, for instance, e.g. 0:00-8:15, and 11:30-17:00. The agent apparatus 20 further communicates via its interface 21 to the user device (e.g. David's smartphone) and sends a message such as: “Everybody is available from 14:00. The weather should be nice”.

David further confirms the start time via a message such as:

“that sounds great”.

Furthermore, the application 24b on the planning unit 24 on the agent apparatus updates the predefined “walk plan template” as:

Requirement 1: users associated with the event=David, Alice, Bob, and Charlie

Requirement 2: start time=NIL; 14:00

Requirement 3: duration=NIL; obtain from user or from the information data

Requirement 4: location=NIL; obtain from user or from the information data and moves forward to the next action.

Action 3:

At 209, in action 3, the application 24b on the agent apparatus 20 resolves the third requirement 3 (duration) for the exemplary predefined “walk plan template”.

Since, the application 24b on the planning unit 24 cannot detect the “duration” of the activity based on the parsed information data, the agent apparatus 20 contacts the user device 27a, and requests additional information based on the requirements of the predefined “walk plan template”. The communication is conducted with a message as:

“how long would you like to walk?”

wherein, the communication is performed via the interface unit 21 to e.g. David's smartphone (user device). Next, David further provides an answer as:

“About one hour”

wherein the message is further received with the interface unit 21, is further compiled with application 22a and parsed with application 22b on the event analyzing unit 22 of the agent apparatus 20, and the application 24b on the planning unit updates the exemplary predefined “walk plan template” as follows:

Requirement 1: users associated with the event=David, Alice, Bob, and Charlie

Requirement 2: start time=14:00

Requirement 3: duration=1:00

Requirement 4: location=NIL; obtain from user or from the information data

and moves forward to the next action.

Action 4:

At 210, in action 4, the application 24b on the agent apparatus 20 resolves the fourth requirement 4 (location) for the exemplary predefined “walk plan template”.

Since, the application 24b on the planning unit 24 cannot detect the “location” of the activity based on the parsed information data, the agent apparatus communicates with all members in the broadcast list via a message such as:

“Any recommendation on the walk location?”

and, for example, obtains a message from Alice (a member in the broadcast list), such as:

“One hour walk in forest near Waterloo”

and, furthermore, the application 24b on the planning unit 24 updates the predefined “walk plan template” as follows:

Requirement 1: users associated with the event=David, Alice, Bob, and Charlie

Requirement 2: start time=14:00

Requirement 3: duration=1:00

Requirement 4: location=Trajectory near Waterloo.

Next, at 211, the agent apparatus recommends the completed plan, which is based on the predefined “walk plan template”, to all members in the broadcast list as a plan and planned event, respectively.

After the confirmation, at 212, the planning unit 24 completes planning the event by adding the plan and the event, respectively, to the calendar of all member in the broadcast list of “family”.

Additionally, the predefined template “walk plan template” may further include predefined third party service information, and in such a case, for example, the agent apparatus can plan for the journey from home to waterloo and back, and uses third party information such as a public transport schedules, and then book a public transport ticket for all members, as discussed above, e.g. in cases that also an authorization for booking of tickets is included in the walk plan template.

In some embodiments, the agent apparatus may cause resources to be allocated, e.g. by using a service to book a restaurant, and then, if the plan is cancelled, the restaurant reservation should be cancelled, too.

In some embodiments, a plan may introduce constrains on the calendars, e.g. it can mark a family member status as “busy”.

In some embodiments, multiple plans may be reconciled with each other, for example, when Alice has a plan to have a friend stay over and Bob wants to eat with the family at the same time, the planning unit may recommend a reconcile plan and the agent apparatus may suggest a resolution for instance, that the friend join.

As mentioned, in some embodiments, the agent apparatus may provide an alert notification to the users associated with the detected event.

In the following, an example for a plan including tracking and an alert notification is presented, wherein, the agent apparatus provides a plan, then the tracking unit 25 tracks the time and location of the users associated with the planned event. Furthermore, when a sudden event is detected, then the agent apparatus, e.g. 20, provides a notification message to the users associated with the detected sudden event and provides an alert notification.

In an exemplary plan including a sudden event, Bob, a member of the broadcast list family communicates with the agent apparatus 20 via a voice command, such as:

“Agent, remind Alice to pick up Charlie from art school at 16:00”.

The agent apparatus tracks the time and location of Alice and obtains the tracking information for example at 15:00, and further estimates a driving distance of 20 minutes away from Charlie. Moreover, at 15:35, the agent apparatus tracks Charlie's location via a sensor of his device and determines his location at the known place “art school”.

The agent apparatus may further being programmed with an “If-Then” flow statement such as:

“Track Estimated Time Arrival (ETA) of Alice to the art school!”

If: ETA>20 minutes,

Then: provide an alert notification

and

“Track estimated time arrival (ETA) of Alice to the art school!”

If: ETA<20 minutes,

Then: wait

In the exemplary case that Alice seems to forget the planned event, the agent apparatus estimates an ETA more than 20 minutes. Hence, the tracking unit in the agent apparatus detects a sudden event and provides an alert notification to Alice and Charlie (users associated with the sudden event), and further notifies Charlie with a message, such as:

“Alice is coming, but running late”.

In some embodiments, the agent apparatus may be based on a platform of the instant messaging application installed on the user device.

As mentioned above, in some embodiments, the agent apparatus may include a broadcast list and the user may add e.g. family members to the broadcast list of “family”. Hence, the agent apparatus may be able to communicate with all family members in the broadcast list simultaneously.

Moreover, the agent apparatus may recommend an event to the members of the broadcast list. For instance, the agent apparatus may recommend a restaurant that all family members in the broadcast list of “family” may be interested to visit, or the agent apparatus may provide information that some family members, such as the parents, are unaware of the event and may consider the information for a taken decision.

As mentioned, the agent apparatus or the user may create a broadcast list, e.g. for family members. Thus, the agent apparatus can engage in family conversations, e.g. performed orally or via a messaging application, and may e.g. recommend a plan, may assist with arranging a plan and may further plan an event. In some embodiments, the agent apparatus may provide a convenient way to access family information away from home.

In the following, an example for the recommended event is presented, wherein the agent apparatus engages in family conversations, provides information that the family member are unware of that, and further recommends restaurants to the family member.

An example of when the agent apparatus provides a recommended event is as follows:

An arbitrary user named Alice sends a message to the members of the broadcast list of “family” in an instant messaging application such as:

“Let's eat out tonight”

Then, Bob, another member of the broadcast list “family” replies with a message such as:

“Cool. Where?”

Next, the agent apparatus also engages in the conversation with a message and provides a recommended event, which is a restaurant that the family visited in the past and all ember enjoyed. The conversation is followed by the message from the agent apparatus recommending two restaurants, such as:

Agent: “Cuccina and Colibri have availability”

and furthermore, Alice, confirms the acceptance of the recommended event and requests the agent apparatus to plan a “restaurant visit event” via a message such as:

“Great, Colibri for 3!”.

The Agent apparatus furthers provides information that family members are unware of via a message such as:

“Charlie is talking to Carol about sleeping over”

wherein, Carol is a friend of Charlie. Hence, Alice considers the provided information and the conversation follows by a new message by Alice, such as:

“I see. Make that 4 then”.

As a result, the agent apparatus plans a “visit restaurant” event for four persons, as discussed above.

As mentioned, in some embodiments, the agent apparatus may run based on an instant messaging service and therefore, there is no need to build a chat function into the agent apparatus. In such an embodiment, the notifications are sent by chat, and may include all users associated with the detected event, hence, they can respond to the situation.

In the following, an example when the agent apparatus detects a sudden event and initiates an organized response is presented.

Charlie, which is a member of the broadcast list “family”, carries a user device having a GPS sensor, therefore, the agent apparatus is able to track him.

The agent apparatus detects a sudden event, when Charlie forgets his dentist appointment and sends a message as an alert notification to the broadcast list “family”, including all family members, such as:

“Charlie, do you have forgotten your dentist appointment?”

Furthermore, Charlie obtains the alert notification message and responds via a text message as:

“Omg, . . . Alice, can you give me a drive?”

wherein Alice responds via a text message to the broadcast list of “family”, such as:

“Where are you? I'll pick you up!”

Moreover, the agent apparatus tracks all users in the broadcast list of “family” and estimates the distance to Charlie's location, and the dentist address (event location), and provides additional information that family members are unware of it via a message such as:

“Bob is actually closer, you won't make it in time, Alice”

Next, Bob responds to the broadcast list of “family” with a message, such as:

“I can't make it. I'm in a meeting, Agent, would you call a taxi?”

Following the conversation, the agent apparatus plans an event, conducts a third party service communication and provides a plan including calling a taxi service, and sends a message, such as:

“A taxi will pick you up in 10 min”

Moreover, the agent apparatus tracks the time of the event and the location of the associated users (e.g. Charlie and Bob) with respect to the dentist location (event location).

It should be recognized that in the embodiments methods are described with an exemplary ordering of method steps. The specific ordering of method steps is however given for illustrative purposes only and should not be construed as binding. For example, the ordering of 104 and 105 in the embodiment of FIG. 5 may be exchanged. In addition, the ordering of 106, 107 and 109 in the embodiment of FIG. 5 may be exchanged. Other changes of the ordering of method steps may be apparent to the skilled person.

Please note that the division of the agent apparatus 10 into units 11 to 16 is only made for illustration purposes and that the present disclosure is not limited to any specific division of functions in specific units. For instance, the agent apparatus 10 could be implemented by a respective programmed processor, field programmable gate array (FPGA) and the like.

The methods described herein can also be implemented as a computer program causing a computer and/or a processor, such as processor 18 discussed above, and/or circuitry to perform the method, when being carried out on the computer and/or processor. In some embodiments, also a non-transitory computer-readable recording medium is provided that stores therein a computer program product, which, when executed by a processor, such as the processor and/or circuitry described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An agent apparatus comprising:
an interface configured to obtain information data;
an event analysis unit configured to analyze the information data for planning an event and to output an analysis result to the planning unit; and
a planning unit configured to plan the event based on a set of predefined plan templates being representative of different types of events and based on the analysis result.

(2) The agent apparatus of (1), wherein the planning unit is further configured to map the event to a template of the set of predefined plan templates.

(3) The agent apparatus of (1) or (2), wherein the event analysis unit is further configured to compile the information data and to parse event related information.

(4) The agent apparatus of anyone of (1) to (3), wherein the interface is further configured to use instant messaging for providing at least one of: a plan, a recommendation of an event, and a notification.

(5) The agent apparatus of anyone of (1) to (4), wherein the planning unit is further configured to recommend an event and to provide a plan for the recommended event, based on the information data.

(6) The agent apparatus of anyone of (1) to (5), wherein the event analysis unit is further configured to detect a sudden event based on the information data.

(7) The agent apparatus of anyone of (1) to (6), further comprising a notification unit configured to provide an alert notification to the users associated with the detected event.

(8) The agent apparatus of anyone of (1) to (7), further comprising a probability estimation unit configured to compute a probability for a user activity based on a statistical analysis of past activities of the user and the information data.

(9) The agent apparatus of anyone of (1) to (8), wherein the planning unit is further configured to recommend a frequently performed user activity as a recommended event.

(10) The agent apparatus of anyone of (1) to (9), wherein the tracking unit is further configured to track users associated with a planned event, based on the start time and the location of the planned event.

(11) A method for controlling an agent apparatus, comprising:
obtaining information data;
analyzing the information data for planning an event; and
planning the event based on a set of predefined plan templates being representative of different types of events.

(12) The method of (11), further comprising mapping the event to a template of the set of predefined plan templates.

(13) The method of (11) or (12), further comprising compiling the information data and parsing event related information.

(14) The method of anyone of (11) to (13), further comprising using instant messaging for providing at least one of: a plan, a recommendation of an event, and a notification.

(15) The method of anyone of (11) to (14), further comprising recommending an event and providing a plan for the recommended event, based on the information data.

(16) The method of anyone of (11) to (15), further comprising detecting a sudden event based on the information data.

(17) The method of anyone of (11) to (16), further comprising providing an alert notification to the users associated with the detected event.

(18) The method of anyone of (11) to (17), further comprising computing a probability for a user activity based on a statistical analysis of past user activities of the user and the information data.

(19) The method of anyone of (11) to (18), further comprising recommending a frequently performed user activity as a recommended event.

(20) The method of anyone of (11) to (19), further comprising tracking users associated with a planned event, based on the start time and the location of the planned event.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

(23) An agent apparatus comprising circuitry configured to perform the method of anyone of (11) to (20).

The present application claims priority to European Patent Application 17164197.0 filed by the European Patent Office on 31 Mar. 2017, the entire contents of which being incorporated herein by reference.

1. An agent apparatus comprising:
an interface configured to obtain information data;
an event analysis unit configured to analyze the information data for planning an event and to output an analysis result to the planning unit; and
a planning unit configured to plan the event based on a set of predefined plan templates being representative of different types of events and based on the analysis result.

2. The agent apparatus of claim 1, wherein the planning unit is further configured to map the event to a template of the set of predefined plan templates.

3. The agent apparatus of claim 1, wherein the event analysis unit is further configured to compile the information data and to parse event related information.

4. The agent apparatus of claim 1, wherein the interface is further configured to use instant messaging for providing at least one of: a plan, a recommendation of an event, and a notification.

5. The agent apparatus of claim 1, wherein the planning unit is further configured to recommend an event and to provide a plan for the recommended event, based on the information data.

6. The agent apparatus of claim 1, wherein the event analysis unit is further configured to detect a sudden event based on the information data.

7. The agent apparatus of claim 6, further comprising a notification unit configured to provide an alert notification to the user associated with the detected event.

8. The agent apparatus of claim 1, further comprising a probability estimation unit configured to compute a probability for a user activity based on a statistical analysis of past activities of the user and the information data.

9. The agent apparatus of claim 1, wherein the planning unit is further configured to recommend a frequently performed user activity as a recommended event.

10. The agent apparatus of claim 1, wherein the tracking unit is further configured to track users associated with a planned event, based on the start time and the location of the planned event.

11. A method for controlling an agent apparatus, comprising:
obtaining information data;
analyzing the information data for planning an event and outputting an analysis result; and
planning the event based on a set of predefined plan templates being representative of different types of events and based on the analysis result.

12. The method of claim 11, further comprising mapping the event to a template of the set of predefined plan templates.

13. The method of claim 11, further comprising compiling the information data and parsing event related information.

14. The method of claim 11, further comprising using instant messaging for providing at least one of: a plan, a recommendation of an event, and a notification.

15. The method of claim 11, further comprising recommending an event and providing a plan for the recommended event, based on the information data.

16. The method of claim 11, further comprising detecting a sudden event based on the information data.

17. The method of claim 16, further comprising providing an alert notification to the users associated with the detected event.

18. The method of claim 11, further comprising computing a probability for a user activity based on a statistical analysis of past user activities of the user and the information data.

19. The method of claim 11, further comprising recommending a frequently performed user activity as a recommended event.

20. The method of claim 11, further comprising tracking users associated with a planned event, based on the start time and the location of the planned event.
